(19) United States
(12) Patent Application Publication
(10) Pub. No.: US 2004/0215485 A1
(43) Pub. Date: Oct. 28, 2004

(54) Method for returning prescription medication

(76) Inventor: Peter M. Lasorsa, Bartonville, IL (US)

Correspondence Address: CATERPILLAR INC., 100 N.E. ADAMS STREET, PATENT DEPT., PEORIA, IL, 616296490

(21) Appl. No.: 10/420,655

(22) Filed: Apr. 22, 2003

(51) Int. Cl. G06F 17/60

(52) U.S. Cl. 705/2; 705/1

(57) ABSTRACT

A method of administering a prescription medication is disclosed. The prescription medication is separated into at least two vessels. At least one vessel is sealed. Prescription medication from the first vessel is consumed. The second unopened vessel is returned for credit.

### TECHNICAL FIELD

The present disclosure relates to a method of administering a prescription medication. The prescription medication is separated into at least two vessels. Prescription medication from the first vessel is consumed. The second unopened vessel is returned for credit.

### BACKGROUND

Currently, a person goes to the doctor when the person complains of an illness or other problem and the doctor may prescribe medication to combat the illness or problem. The medication prescribed by the doctor is available from a pharmacist and with the doctor's prescription.

The person may start to take the prescription medication and have an adverse reaction or the prescription medication may not help the person with his illness or problem. Currently, there is no method in place to return the unused prescription medication, so the prescription medication is discarded.

The present invention is directed to overcoming one or more of the problems set forth above.

### SUMMARY OF THE INVENTION

A method of providing credit for an unopened vessel of a prescription medication is disclosed. The method includes the steps of, filling a first vessel with a first predetermined count of said prescription medication, filling a second vessel with a second predetermined count of said prescription medication, sealing the second vessel, providing the first and second vessels to a customer, receiving the second unopened vessel from the customer, and providing credit for the second vessel.

### BRIEF DESCRIPTION OF THE DRAWINGS

FIG. 1 is a flow chart of one embodiment of a method of returning a prescription medication for credit.

FIG. 2 is an example of a second vessel, which may be used in returning prescription medication.

FIG. 3 is a flow chart of one embodiment of a method of establishing a dosage criteria associated with a prescription medication.

FIG. 4 is a flow chart of one embodiment of a method of providing credit for returning a prescription medication.

### DETAILED DESCRIPTION

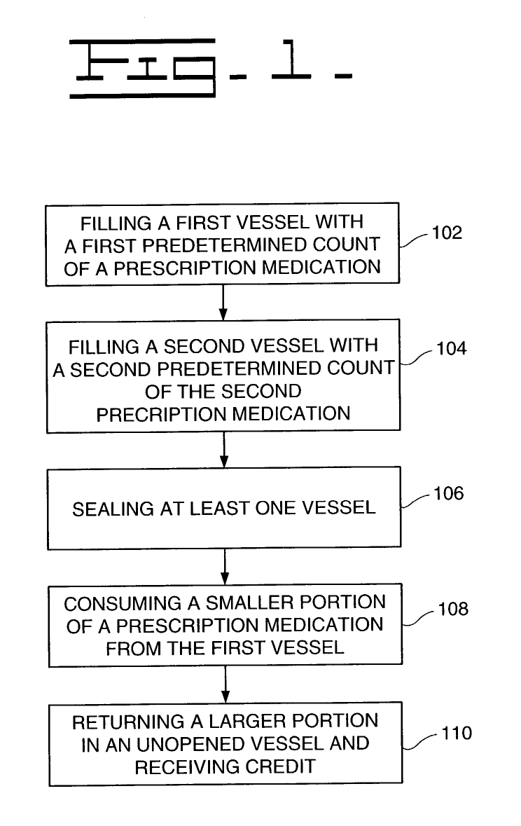

The present disclosure is associated with returning an unopened vessel of a prescription medication for credit. The prescription medication may be for example a prescribed drug, an herb, or a vitamin. FIG. 1 illustrates one embodiment of returning a prescription medication including the step of sealing at least one vessel, consuming a smaller portion of a prescription medication from a first vessel and receiving a larger portion in an unopened vessel and issuing credit. For example the prescription medication may be a pill, tablet, capsule or liquid. In the exemplary embodiment of FIG. 1, a pharmacist receives a prescription from a physician to prepare a prescription medication for a customer. The prescription is for 50-xyz pills. In a first control block 102, the pharmacist in filling the prescription medication may place a first number of pills (e.g. 5-xyz pills) in a first vessel. In a second control block 104, a pharmacist may place a second number of pills (e.g. 45-xyz pills) in a second vessel.

In a third control block 106, the pharmacist seals the second vessel. For example, the second vessel may be sealed by shrink wrapping and covering at least one end of the second vessel, attaching a tamper proof strip across at least one end of the second vessel, vacuum sealing the second vessel, placing a device in the second vessel which changes colors when the second vessel is opened, placing a one-time locking cap on the second vessel, and blister packing the prescription medication.

In a fourth control block 108, the customer takes at least one xyz pill from the first vessel and consumes it. If the customer has an adverse reaction from the xyz pill, the customer may call a physician and tell the physician of the adverse reaction. The physician may instruct the customer to not take any more xyz pills and instead start taking abc pills. The physician calls the pharmacist and issues a new prescription, 50-abc pills.

In a fifth control block 110, the customer returns the sealed unopened second vessel containing 45-xyz pills to the pharmacy. Unopened in this context may be described as: the lid or seal have not been removed, pierced, or breached, and/or the vessel has not been broken, pierced, or breached. The customer may be credited for the return of the prescription medication (e.g. the unopened vessel).

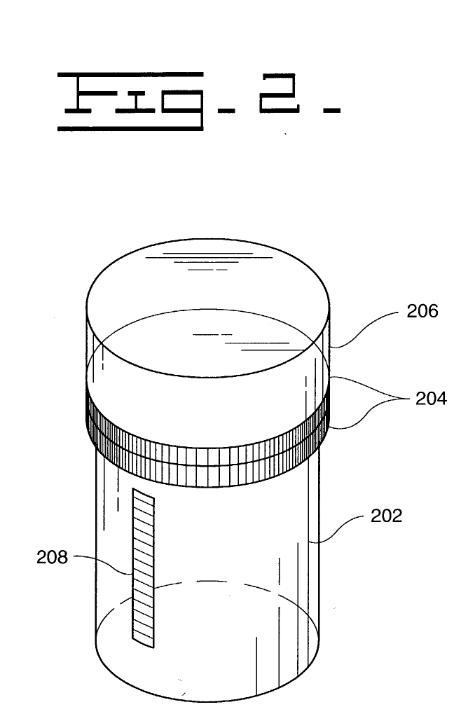

The first vessel and second vessel may be two separate containers, or they may be associated with the same container. For example FIG. 2 illustrates a container having a first vessel 206, and a second vessel 202. In this manner the customer may use prescription medication from the first vessel 206 without disturbing the integrity of the second vessel 202. In one embodiment the second vessel 202 may include a feature, like a detection strip 208, that provides an indication of whether the second vessel 202 has been opened.

A seal 204, which seals the second vessel 202 containing the largest portion of the prescription medication, is illustrated.

A first vessel 206, which may store a portion of the prescribed medication is illustrated. The first vessel 206 has at least one opening, which may be covered with a cap or some other form of sealing device. In one embodiment, the first vessel 206 removes from the second vessel 202 so that the user may access the contents of the second vessel 202 easier.

In one embodiment the detection strip 208 may detect a characteristic indicative of whether the second vessel 202 has been opened or tampered with. For example, the detection strip 208 may detect at least one of the degrading contents of the second vessel 202 (e.g. biological degrading, etc.), the changes in the climate inside the second vessel 202, and the presence of a foreign substance inside the second vessel 202.

In one embodiment the detection strip 208 may change color based on evidence that the prescription medication inside the second vessel 202 has biologically degraded, possibly due to external forces. The external forces may be at least one of heat, cold, and sunlight. For example, the detection strip 208 may be gray in color and change to bright blue if the inside temperature drops below a first threshold (e.g. 40 degrees F.) or rises above a second threshold (e.g. 90 degrees F.), or if exposed to direct sunlight for an extended time period (e.g. over an hour). The detection strip 208 may remain bright blue even after the temperature returned to a normal degree.

Alternatively, the detection strip 208 may detect a foreign substance inside the second vessel 202. For example, the detection strip 208 may be gray and change color to blue if any substance other than oxygen, and the chemicals incorporated in the prescription medication are detected inside the second vessel 202. In this embodiment, a prescription medication specific detection strip type may be used for each type of prescription medication. For example, prescription medication xyz may use test strip type 1, prescription medication abc may use test strip type 2 and so forth with each different prescription medication using an appropriate test strip type.

The detection strip 208 may have adhesive on one side and may be attached to the inside of the second vessel 202 via adhesive. Alternatively, the detection strip 208 may be placed inside the second vessel 202 without being attached to the second vessel 202.

In one embodiment the second vessel 202 may have a tamper proof strip attached across one end of the second vessel 202.

The second vessel 202 may include a device, which changes colors when the second vessel 202 is opened. In one embodiment, the device 404 may be placed inside the second vessel 202. In another embodiment, the device may be attached via adhesive to the inside wall of the second vessel 202. For exemplary purposes only, the device may be white in color and turn bright red if the pills inside the second vessel 202 are exposed to air as a result of the opening of the second vessel 202. The change in color alerts the user or other persons that the second vessel 202 was opened.

The second vessel 202 may have a one-time locking cap, sealing the second vessel 202. The one-time locking cap is constructed in such a way that once positioned on the second vessel 202 it may only be taken off the second vessel 202 once. In one embodiment, a blister package is used to distribute the prescription medication.

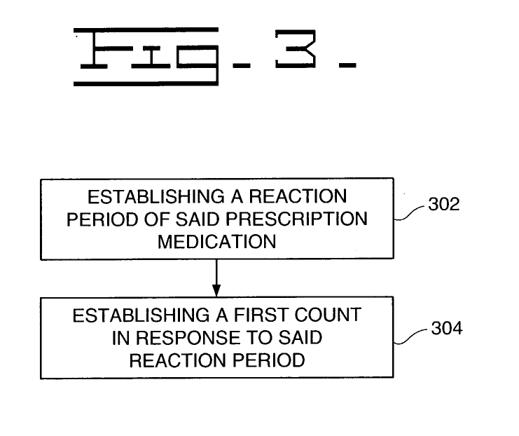

FIG. 3 illustrates one embodiment of a method of establishing a dosage criteria associated with a prescription medication, including establishing a reaction period of the prescription medication 302, and establishing a first count in response to the reaction period 304. The first count may be less than the prescribed amount. The dispensing dosage criteria may be used to decrease costs by establishing economical guidelines for dispensing prescription medication based on historical data, medical advice, third party advice or drug manufacturer's advice. The dispensing dosage criteria may be based on the negative reactions to specific prescription medications. In one embodiment, the dosage may be dispensed in two vessels. The first vessel may have a first dispensed amount of the dosage and the second vessel may have a second dispensed amount of the dosage. The first dispensed amount may be based on a reaction period, cost characteristic or both. The second dispensed amount may be based on reaction period, cost characteristic or both. Alternatively, the second dispensed amount may be based on the first dispensed amount. The reaction period may be a time period during which a person may have a reaction to the prescription medication, if a person were going to have a reaction to the prescription medication at all. In addition, a reaction period may be broken down further into a selected reaction period. The selected reaction period may be based on at least one of, cost, length of stability of the drug, susceptibility of the drug to changes in climate and sunlight, and reaction period. In one embodiment the selected reaction period associated with a drug may be based on a cost characteristic of the drug. (e.g. the more expensive the cost of the drug, the smaller the first quantity may be). For example, if a drug cost $20 per pill and 50 pills comprised the prescription; it may be economical to extend the reaction period (based on at least one of a reaction period, cost characteristic or both) from 3 pills to 10 pills based on the cost that may be recovered if 40 pills were returned. Alternatively, it may not be economical to extend the first amount from 3 pills to 10 pills if the cost of the pills were $1 per pill, and the prescription were for 20 pills, because the dollar amount recoverable may not be significant enough.

In one embodiment, a first count may be established in response to the cost characteristic. The cost characteristic may be established based on at least one of historical data, medical advice, pharmaceutical advice, third party advice and a cost ratio matrix. The cost ratio matrix may be based on at least one of, the historical data, medical advice, pharmaceutical advice, third-party advice and the cost associated with a prescription medication. The cost characteristic may be a price associated with a prescription medication. For example, prescription medication abc cost $5 per pill and prescription medication xyz cost $10 per pill. The cost characteristic of each prescription medication may be different. For example, in response to the cost characteristic of the xyz pill, the pharmacist may fill the first vessel with a first count of 5-xyz pills. Alternatively, in response to the cost characteristic of the abc pill, the pharmacist may fill the first vessel with a first count of 7-abc pills.

In one embodiment, a first count may be established in response to the reaction period. The reaction period for each drug may be different. For example, some drugs, like the abc drug may cause reactions, if at all, after one pill and other like the xyz may not cause a reaction until seven or eight pills are consumed, if at all. Additionally, the reaction may be time based. (e.g. the reaction may occur after 24 hours of the consumption of the first pill, or within 2 days of the consumption of the third pill). In the above example, the first count for the abc may be one pill and the first count for the xyz may be seven or eight pills.

In one embodiment, a first count may be established in response to a cost characteristic and a reaction period. The pharmacist may use a chart such as the cost ratio matrix, which may take into account both the cost characteristic and reaction period. Combining the cost characteristic and reaction period may establish an economically feasible first count.

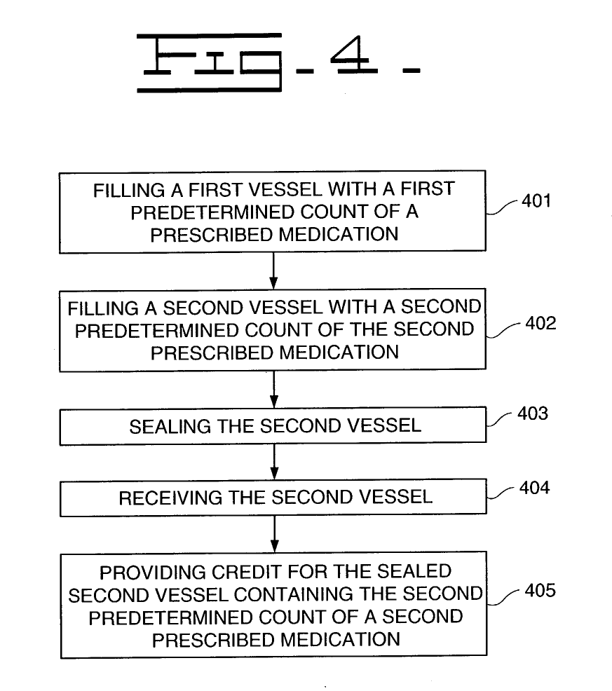

FIG. 4 illustrates one embodiment of a method of accepting the return of an unopened vessel of a prescription medication, including the steps of, filling a first vessel with a first prescription medication having a first predetermined amount, filling a second vessel with a second prescription medication having a second predetermined amount, sealing the second vessel, receiving the second vessel and providing credit for the sealed second vessel containing the second predetermined count of the prescription medication. For example, a person visits his physician complaining of an ailment. The physician prescribes a prescription medication (e.g. 50 abc pills) to the person. The person drives to the local pharmacy and hands the prescription for 50 abc pills to at least one of the pharmacist, clerk, consultant, and assistant. In a first control block 401, at least one of the pharmacists, clerk, consultant, and assistant may fill a first vessel with a first predetermined count of a first prescription medication.

In one embodiment, determining the first predetermined count associated with the first vessel may be based on a cost ratio matrix. The cost ratio matrix may be established by at least one of a corporation, drug company, pharmacist, consultant, medical association, health care management organization and health care organization. The cost ratio matrix may comprise an array of rows and columns. The cost ratio matrix may reside on a computer database. The cost ratio matrix may include characteristics of a prescription medication, one or more of which may be used as factors associated with determining a first predetermined count. The factors associated with determining a first predetermined count may be based on historical data and may include; cost of the prescription medication, wide-spread use of the prescription medication, probability of a reaction to the prescription medication time period during which a reaction is likely to occur, if there is to be one, and stability of the prescription medication. A reaction period associated with a prescription medication may be the period during which a reaction to the prescription medication is most likely to occur, if a reaction is going to occur at all. The reaction may be a positive reaction (e.g. prescription medication working), or a negative reaction (e.g. consumer has an adverse reaction to the prescription medication). The second predetermined count for the second vessel may be based on the first predetermined count for the first vessel. For example, assume a prescribed medication (e.g. comprising 50 pills) that was very expensive (e.g. $10.00 per pill) and based on historical data people had a high probability of an adverse reaction (e.g. one-in-ten people had a reaction to the prescription medication). Based on these factors, the pharmacist may decide to split the prescription medication amount into two vessels. The first vessel may include a small amount of the prescription medication, and the second vessel may include the remainder of the prescription medication. In this manner, if the person has an adverse reaction, they may return the second remaining portion for credit. In the above example the prescription medication would rate high on the cost ratio matrix and therefore the first vessel would be filled with a small amount (e.g. 3 pills) of the prescription medication. Additionally, based on the first predetermined count of 3 for the first vessel, the second vessels predetermined count would be 47 (e.g. 50 pills in the initial prescription medication, minus 3 pills in the first determined count for the first vessel).

In a second control block 402, a third party may fill a second vessel with a second predetermined count of a second prescription medication.

In one embodiment, determining how to fill the second vessel with a second prescription medication may be based on a cost ratio matrix, as described above, relative to the first vessel.

In a third control block 403, a third party may seal the second vessel.

In a fourth control block 404, a person may return the unopened second vessel to the place of purchase. In one embodiment, the person returning the sealed second vessel of the prescription medication may have time restrictions, as to how long after picking up the prescription medication they may return the sealed second vessel to the place of purchase. The time restriction may be based on the reaction period, cost characteristic, and useful life or expiration of the prescription medication. The time limit for each type of prescription medication may be based on at least one of, historical data, type of prescription medication, comment from a third party and comment from the maker of the prescription medication. For example, a least one of a pharmacist, clerk, consultant and assistant may include instructions via at least one of a sheet of a paper, a piece of cardboard, and a digital data instruction with the prescription medication. For example the instructions may be typed, handwritten, and imprinted on the label, which may be affixed to a first or second vessel, or the instructions may be handed to the person picking up the prescription medication. The instructions for the prescription medication may state that the pills in the sealed second vessel may only be returned within 24 hours after the prescription medication is picked up from the place of purchase.

Each type of prescription medication may have a different time limit with regards to how long after the time of pick-up or prescription fulfillment, the person may return the sealed second vessel to the place of purchase.

In a fifth control block 405, credit is given by the place of purchase of the prescription medication. Credit may be given to at least one of, the person returning the sealed second vessel, the third party who paid for the prescription medication, and the insurance company that paid for the prescription medication and the company that paid for the prescription medication.

Other aspects, objects and advantages of this disclosure may be obtained from a study of the drawings, the disclosure and the appended claims.

What is claimed is:

1. A method of accepting return for an unopened vessel of a prescription medication comprising the steps of:
filling a first vessel with a first amount of said prescription medication;
filling a second vessel with a second amount of said prescription medication;
sealing said second vessel;
providing said first and second vessels to a customer;
accepting return of said second vessel from said customer in said unopened condition; and
providing credit for said second vessel.

2. The method as set forth in claim 1, wherein the step of filling said first vessel with said first prescription medication having said first predetermined count further comprises the step of determining said first predetermined count based on a cost ratio matrix.

3. The method as set forth in claim 1, wherein the step of filling said second vessel with said second prescription medication having said second predetermined count further comprises the step of determining said second predetermined count based on a cost ratio matrix.

4. The method as set forth in claim 1, wherein the step of filling said first vessel with said first prescription medication having said first predetermined count further comprises the step of determining said first predetermined count based on a prescription medication chart.

5. The method as set forth in claim 4, wherein said prescription medication chart includes a drug reaction time period. The method of establishing a dosage criteria associated with a prescription medication, a prescription medication having a prescribed amount, comprising the steps of:
establishing a reaction period of said prescription medication;
establishing a first count of said prescription medication in response to said reaction period;
establishing a second count of said prescription medication in response to said first count;
filling a first vessel with said first count; and
filling a second vessel with said second count.

6. The method as set forth in claim 6, further comprising the step of establishing a cost characteristic of said drug.

7. The method as set forth in claim 6, further comprising the step of establishing said first count in response to said cost characteristic and said reaction period.

8. The method as set forth in claim 6, wherein the step of establishing said first count may be in response to at least one of a cost characteristic and said reaction period.

9. The method of accepting the return of an unopened vessel of a prescription medication comprising the steps of:
filling at least two vessels with said prescription medication;
sealing at least one of said vessels;
providing at least two of said vessels to a customer;
accepting return of at least one of said vessels; and
providing credit for at least one of said vessels.
